(19) United States
(12) Patent Application Publication
(10) Pub. No.: US 2025/0296217 A1
(43) Pub. Date: Sep. 25, 2025

(54) POWER TOOL WITH ENCLOSED GEARCASE

(71) Applicant: MILWAUKEE ELECTRIC TOOL CORPORATION, Brookfield, WI (US)

(72) Inventors: Brian T. Callen, Wauwatosa, WI (US); Hugh A. Dales, Germantown, WI (US); Benjamin Gordon, Brookfield, WI (US); Bonder De Liang Pang, Yulin City (CN)

(21) Appl. No.: 19/084,145

(22) Filed: Mar. 19, 2025

Related U.S. Application Data
(60) Provisional application No. 63/567,262, filed on Mar. 19, 2024.

(51) Int. Cl. B25F 5/00; B25B 21/02; B25F 5/02

(52) U.S. Cl. CPC B25F 5/001; B25F 5/02; B25B 21/02

(57) ABSTRACT

A power tool including a housing with a first housing portion and a second housing portion, the first housing portion and the second housing portion collectively defining a head housing portion. The power tool also includes a motor supported within the head housing portion and including an output shaft, a gear case completely enclosed by the head housing portion, a gear assembly engaged with the output shaft and supported within the gear case, and a drive assembly driven by the gear assembly and supported within the head housing portion.

### CROSS-REFERENCE TO RELATED APPLICATIONS

This application claims priority to U.S. Provisional Patent Application No. 63/567,262, filed on Mar. 19, 2024, the entire contents of which are incorporated herein by reference.

### FIELD

The present disclosure relates to power tools, and more particularly to rotary impact tools.

### BACKGROUND

Rotary impact tools are typically utilized to provide a striking rotational force, or intermittent applications of torque, to a tool element or workpiece (e.g., a fastener) to either tighten or loosen the fastener.

### SUMMARY

The present disclosure provides, in one aspect, a power tool including a housing with a first housing portion and a second housing portion, the first housing portion and the second housing portion collectively defining a head housing portion. The power tool also includes a motor supported within the head housing portion and including an output shaft, a gear case completely enclosed by the head housing portion, a gear assembly engaged with the output shaft and supported within the gear case, and a drive assembly driven by the gear assembly and supported within the head housing portion.

The present disclose provides, in another aspect, a power tool including a housing defining a head housing portion, a motor supported within the head housing portion and including an output shaft defining an axis, a gear case aligned with the motor along the axis and supported within the head housing portion, and a gear assembly engaged with the output shaft and supported within the gear case. The gear assembly includes a pinion gear coupled to the output shaft, a plurality of planet gears meshed with the pinion gear, and a ring gear meshed with the planet gears. The power tool also includes a seal positioned axially between the gear case and the ring gear and a drive assembly driven by the planet gears and supported within the head housing portion.

The present disclosure provides, in another aspect, a power tool including a housing having a first housing portion, a second housing portion coupled to the first housing portion, the first and second housing portions defining a head housing portion, and a nose cap coupled to the head housing portion. The power tool also includes a motor supported within the head housing portion, a gear case supported by the head housing portion, the nose cap coupled to the gear case, a gear assembly engaged with the motor and supported within the gear case, and a drive assembly driven by the gear assembly and supported within the head housing portion.

Other aspects of the invention will become apparent by consideration of the detailed description and accompanying drawings.

### BRIEF DESCRIPTION OF THE DRAWINGS

FIG. 1 is a perspective view of a power tool according to an embodiment of the disclosure.

FIG. 2 is a cross-sectional view of the power tool along line 2-2 of FIG. 1.

FIG. 3 is an exploded view of the power tool, illustrating clamshell halves and a gear case.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

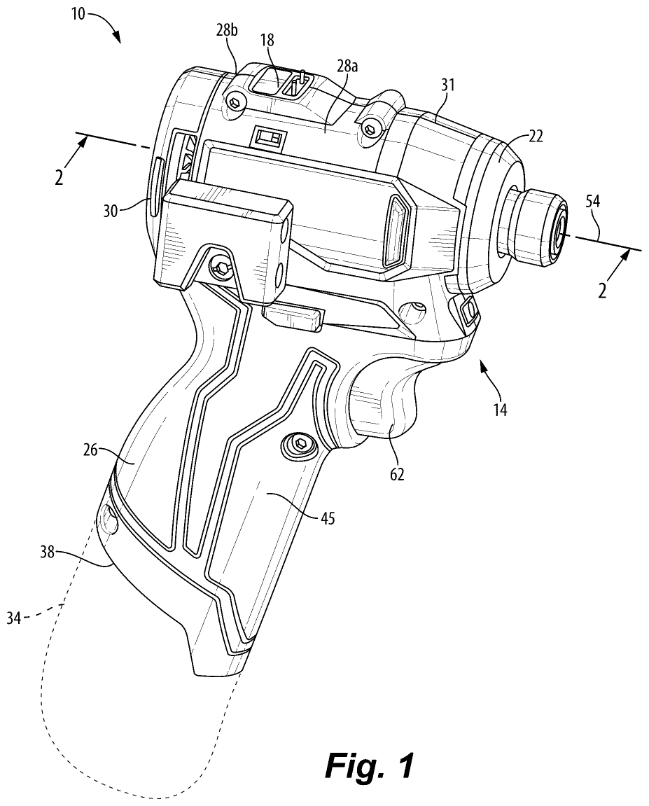

FIG. 1 illustrates an embodiment of a power tool in the form of a rotary impact tool, and, more specifically, an impact driver 10. The impact driver 10 includes a housing 14 with a head housing portion 18, a front nose cap 22 interfaced with the head housing portion 18, and a handle housing portion 26 extending downwardly from the head housing portion 18. In the illustrated embodiment, the handle housing portion 26 and the head housing portion 18 are defined by cooperating first and second clamshell halves or housing portions 28a, 28b.

The illustrated housing 14 also includes a rear end portion 30 that defines a rear end of the head housing portion 18 that is opposite the front nose cap 22. The clamshell halves 28a, 28b can be coupled (e.g., fastened) together at an interface or seam 31. In the illustrated embodiment, seam 31 extends through the rear end portion 30, such that the clamshell halves 28a, 28b, in part, form the rear end portion 30. In other embodiments, the rear end portion 30 can be a separate component coupled to the clamshell halves 28a, 28b.

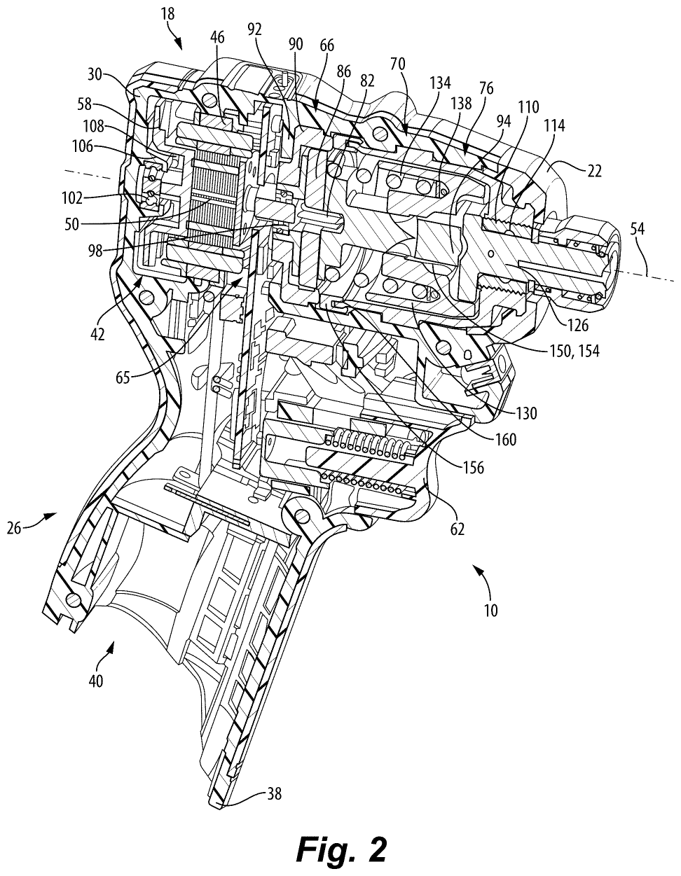

Referring to FIGS. 1 and 2, the impact driver 10 includes a battery 34 removably coupled to a battery receptacle 38, which in the illustrated embodiment, includes a cavity 40 extending into the handle housing portion 26. A motor 42 is supported within the head housing portion 18 and receives power from the battery 34 via connections, pads, and/or battery terminals in the battery receptacle 38 when the battery 34 is coupled to the battery receptacle 38. In the illustrated embodiment, the handle housing portion 26 of the clamshell halves 28a, 28b can be covered or surrounded by a grip portion 45, which may be overmolded on the handle housing portion 26 and around the rear end portion 30.

The battery 34 may be a power tool battery pack generally used to power a power tool, such as an electric drill, an electric saw, and the like (e.g., a 12-volt rechargeable battery pack). The battery 34 may include lithium ion (Li-ion) cells. The 12-volt nominal output voltage of the battery 34 provides an optimal balance between weight/size and power in the illustrated impact driver 10; however, batteries with other nominal voltages may be used in other embodiments.

Now referring to FIG. 2, in the illustrated embodiment, the motor 42 is a brushless direct current (“BLDC”) motor with a stator 46 and a rotor with an output shaft 50 that is rotatable about an axis 54 relative to the stator 46. In other embodiments, other types of motors may be used. A fan 58 is coupled to the output shaft 50 behind the motor 42 to generate airflow for cooling the motor 42 and/or other components of the power tool 10.

Referring to FIG. 2, the impact driver 10 also includes a trigger 62 (including an actuator and a trigger switch) supported by the housing 14 and operable to selectively electrically connects the motor 42 (e.g., via suitable control circuitry provided on one or more printed circuit board assemblies (“PCBAs”) and the battery 34, to provide DC power to the motor 42. In other embodiments, the impact driver 10 may include a power cord for electrically connecting the trigger 62 and the motor 42 to a source of AC power. As a further alternative, the impact driver 10 may be configured to operate using a different power source (e.g., a pneumatic or hydraulic power source, etc.).

In the illustrated embodiment, a PCBA 65 is supported within the head housing portion 18 adjacent a front end of the stator 46. The illustrated PCBA 65 extends perpendicular to the axis 54 and includes one or more Hall-Effect sensors, which provide feedback for controlling the motor 42. The PCBA 65 is in electrical communication with the motor 42, the trigger 62, and terminals of the battery receptacle 38. In the illustrated embodiment, the PCBA 65 includes a plurality of semi-conductor switching elements (e.g., MOSFETs, IGBTs, or the like) that control and distribute power to windings in the stator 46 in order to cause rotation of the rotor and output shaft 50. The PCBA 65 may also include one or more microprocessors, machine-readable, non-transitory memory elements, and other electrical or electronic elements for providing operational control to the impact driver 10.

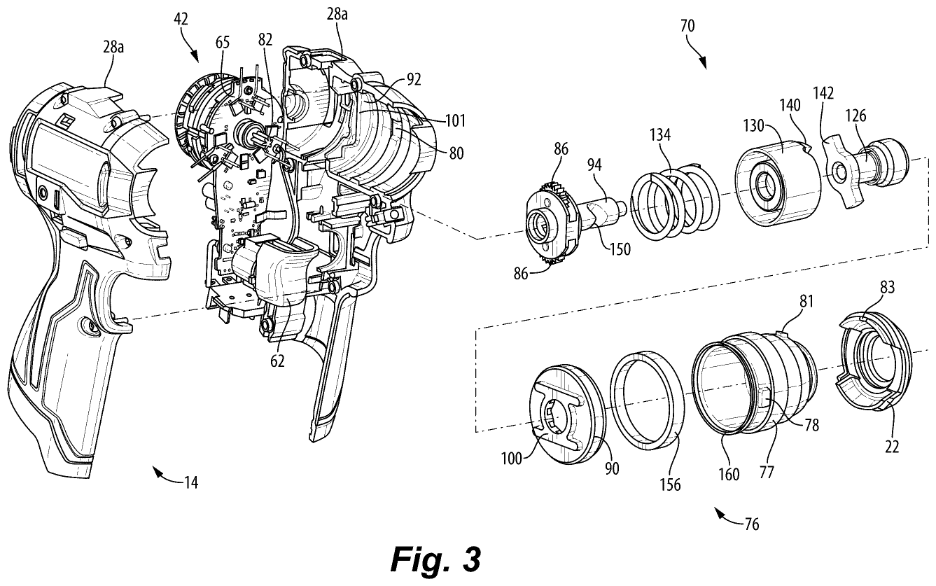

Referring now to FIGS. 2 and 3, the impact driver 10 further includes a gear assembly 66 driven by the output shaft 50 and an impact mechanism 70 coupled to an output of the gear assembly 66. The impact mechanism 70 may also be referred to herein as a drive assembly 70. The gear assembly 66 may be configured in any of a number of different ways to provide a speed reduction between the output shaft 50 and an input of the drive assembly 70. The gear assembly 66 and the drive assembly 70 are housed within a gear case 76 which, turn, is disposed within the housing 14. The illustrated gear case 76 is aligned with the motor 42 along the axis 56. The gear case 76 is enclosed within the head housing portion 18 of the housing 14. In particular, the clamshell halves 28a, 28b collectively enclose the gear case 76, such that no portion of the gear case 76 is exposed or visible from the exterior of the impact driver 10. Stated another way, the gear case 76 is completely enclosed by the clamshell halves 28a, 28b. In other words, the gear case 76 is directly supported within the clamshell halves 28a, 28b. The gear case 76 includes a front gear case 77 with tabs 78 that extend radially outward from the exterior of the front gear case 77 in a direction perpendicular to the axis 56. In other words, the tabs 78 extend toward and engage recesses 80 (only one of which is shown) in the clamshell halves 28a, 28b to inhibit rotation of the front gear case 77 relative to the clamshell halves 28a, 28b (FIG. 3). The front gear case 77 also includes a projection 81 that extends radially outward from the exterior of the front gear case 77 in a direction perpendicular to the axis 56. In other words, the projection 81 extends toward and engages a recess 83 in the front nose cap 22 to inhibit rotation of the front gear case 77 relative to the nose cap 22 (FIG. 3).

With continued reference to FIGS. 2 and 3, the impact driver 10 includes a ring gear 90, which is part of the gear assembly 66. In some embodiments, the ring gear 90 can define the rear end of the gear case 76. The gear assembly 66 includes a pinion gear 82 coupled to the output shaft 50 of the motor 42 and a plurality of planet gears 86 meshed with the pinion gear 82. The ring gear 90 is meshed with the planet gears 86 and rotationally fixed within the housing 14. A rearward face of the ring gear 90 is seated against a dividing wall 92 formed by the clamshell halves 28a, 28b (FIG. 3). Specifically, the rearward face of the ring gear 90 includes a protrusion 100 that is keyed into a corresponding aperture 101 in the dividing wall 92 of the clamshell halves 28a, 28b. The protrusion 100 extends is a direction along the axis 54. The dividing wall 92 separates the gear case 76 from the motor 42.

The planet gears 86 are coupled to a camshaft 94 of the drive assembly 70 such that the camshaft 94 acts as a planet carrier. Accordingly, rotation of the output shaft 50 rotates the planet gears 86, which then advance along the inner circumference of the ring gear 90 and thereby rotates the camshaft 94.

The output shaft 50 is rotatably supported by a first or forward bearing 98 and a second or rear bearing 102. The pinion gear 82, coupled to the output shaft 50, extends through an opening in the dividing wall 92. The impact driver 10 includes a hub or bearing retainer 106, which is formed by the clamshell halves 28a, 28b, and which secures the rear bearing 102 both axially (e.g., against forces transmitted along the axis 54) and radially (i.e., against forces transmitted in a radial direction of the output shaft 50). In the illustrated embodiment, the fan 58 includes a recess 108 and the bearing retainer 106 extends into the recess 108 such that at least a portion of the bearing retainer 106 and at least a portion of the rear bearing 102 overlap the fan 58 along the axis 54 (FIG. 2). This overlapping arrangement advantageously reduces the axial length of the impact driver 10.

The drive assembly 70 of the impact driver 10 will now be described with reference to FIG. 2. The drive assembly 70 is disposed within the gear case 76. The drive assembly 70 includes an anvil 126, extending from the front nose cap 22, to which a tool element (e.g., a socket, not shown) can be coupled for performing work on a workpiece (e.g., a fastener). The drive assembly 70 is configured to convert the constant rotational force or torque provided by the gear assembly 66 to a striking rotational force or intermittent applications of torque to the anvil 126 when the reaction torque on the anvil 126 (e.g., due to engagement between the tool element and a fastener being worked upon) exceeds a certain threshold. In the illustrated embodiment of the impact driver 10, the drive assembly 70 includes the camshaft 94, a hammer 130 supported on and axially slidable relative to the camshaft 94, and the anvil 126. Stated another way, the hammer 130 is configured to reciprocate axially along the camshaft 94 and impart periodic rotational impacts to the anvil 126 in response to rotation of the camshaft 94. So, the anvil 126 is driven by the hammer 130 and is supported for rotation by the gear case 76 via a bushing 110. In other embodiments, the impact driver 10 may include other types of drive assemblies (e.g., an oil pulse drive assembly including an oil-filled cylinder driven by the gear assembly 66 with internal projections configured to impact blades on an anvil extending into the cylinder).

In the illustrated embodiment, the bushing 110 has a knurled exterior surface that interfaces with the gear case 76. In other embodiments, the bushing 110 (FIG. 2) may be threaded, press-fit, or otherwise coupled to the gear case 76. The bushing 110 includes a groove 114 on the inner surface to receive a lubricant, such as grease or oil, for coating the anvil 126 to assist in smooth operation of the impact driver 10 by minimizing friction between movable components. The front nose cap 22 surrounds the anvil 126 and snap fits onto the forward most portion of the gear case 76.

The clamshell halves 28a, 28b further secure the front nose cap 22 to the housing 14 to inhibit removal from the gear case 76. Specifically, at least portions of the front nose cap 22 is disposed between the gear case 76 and the head housing portion 18 in a direction perpendicular to the axis 56.

The drive assembly 70 further includes a spring 134 that biases the hammer 130 toward the front of the impact driver 10. In other words, the spring 134 biases the hammer 130 in an axial direction toward the anvil 126, along the axis 54. A thrust bearing 138 is positioned between the spring 134 and the hammer 130. The thrust bearing 138 allows for the spring 134 and the camshaft 94 to continue to rotate relative to the hammer 130 after each impact strike when lugs 140 (FIG. 3) on the hammer 130 engage with corresponding anvil lugs 142 and rotation of the hammer 130 momentarily stops. The camshaft 94 includes cam grooves 150 in which corresponding cam balls 154 are received (although only one cam ball is illustrated in FIG. 2). The cam balls 154 are in driving engagement with the hammer 130 and movement of the cam balls 154 within the cam grooves 150 allows for relative axial movement of the hammer 130 along the camshaft 94 when the hammer lugs 140 and the anvil lugs 142 are engaged and the camshaft 94 continues to rotate. The axial movement of the hammer 130 compresses the spring 134, which then releases its stored energy to propel the hammer 130 forward and rotate the hammer 130 once the hammer lugs 140 clear the anvil lugs 142.

Referring to FIG. 2, the gear case 76 may contain lubricant, such as grease or oil, for coating the gear assembly 66 and/or drive assembly 70 to assist in smooth operation of the impact driver 10 by minimizing friction between movable components. In the illustrated embodiment, the impact driver 10 includes a gasket or seal 156 to inhibit lubricant from escaping the gear case 76. The seal 156 is disposed between the ring gear 90 and the gear case 76 along a direction parallel to the axis 56. The seal 156 is disposed adjacent the ring gear 90 and couples to the front gear case 77. Specifically, the seal 156 abuts the ring gear 90 and is U-shaped in cross section for receiving an edge or flange 160 of the front gear case 77 to inhibit any lubricant from escaping from the gear case 76. The illustrated seal 156 is made of a flexible, elastomeric material (e.g., rubber) and may be compressed between the ring gear 90 and the front gear case 77 during assembly of the impact driver 10. Alternatively, the seal 156 may be made of other materials suitable for inhibiting lubricant from escaping from the gear case 76.

During operation of the impact driver 10, an operator depresses the trigger 62 to activate the motor 42, which continuously drives the gear assembly 66 and the camshaft 94 via the output shaft 50. As the camshaft 94 rotates, the cam balls 154 drive the hammer 130 to co-rotate with the camshaft 94, and the drive surfaces of hammer lugs 140 to engage, respectively, the driven surfaces of anvil lugs 142 to provide an impact and to rotatably drive the anvil 126 and the tool element. After each impact, the hammer 130 moves or slides rearward along the camshaft 94, away from the anvil 126, so that the hammer lugs 140 disengage the anvil lugs 142.

As the hammer 130 moves rearward, the cam balls 154 situated in the respective cam grooves 150 in the camshaft 94 move rearward in the cam grooves 150. The spring 134 stores some of the rearward energy of the hammer 130 to provide a return mechanism for the hammer 130. After the hammer lugs 140 disengage the respective anvil lugs 142, the hammer 130 continues to rotate and moves or slides forwardly, toward the anvil 126, as the spring 134 releases its stored energy, until the drive surfaces of the hammer lugs 140 re-engage the driven surfaces of the anvil lugs 142 to cause another impact.

Although the disclosure has been described in detail with reference to certain preferred embodiments, variations and modifications exist within the scope and spirit of one or more independent aspects of the disclosure as described. For example, although the power tool is described and illustrated herein as an impact driver 10, aspects of the present disclosure may be implemented in other types of power tools, such as drills, powered screwdrivers, impact drivers, rotary hammers, ratchets, grinders, precision torque tools, and the like.

What is claimed is:

1. A power tool comprising:
a housing including a first housing portion and a second housing portion, the first housing portion and the second housing portion collectively defining a head housing portion;
a motor supported within the head housing portion and including an output shaft;
a gear case completely enclosed by the head housing portion;
a gear assembly engaged with the output shaft and supported within the gear case; and
a drive assembly driven by the gear assembly and supported within the head housing portion.

2. The power tool of claim 1, wherein the gear case is entirely disposed between the first housing portion and the second housing portion.

3. The power tool of claim 1, wherein the output shaft defines an axis, and wherein the gear case includes a tab extending radially outward in a direction perpendicular to the axis towards the housing, the tab received within a recess of the housing to inhibit rotation of the gear case relative to the housing.

4. The power tool of claim 1, wherein the housing includes a nose cap coupled to the gear case.

5. The power tool of claim 4, wherein the drive assembly includes an anvil received in the gear case and extending through the nose cap.

6. The power tool of claim 1, wherein the gear case includes a first gear case portion, a second gear case portion, and a seal between the first gear case portion and the second gear case portion.

7. The power tool of claim 1, wherein the output shaft defines an axis, the gear case aligned with the motor along the axis.

8. The power tool of claim 1, wherein the housing defines a handle housing portion, wherein the power tool further comprises a battery receptacle in the handle housing portion configured to removably receive a battery and provide power to the motor.

9. The power tool of claim 1, further comprising a bushing coupled to the gear case and supports an anvil of the drive assembly for rotation, wherein the bushing includes a groove on an inner periphery that receives a lubricant to minimize friction as the anvil rotates.

10. A power tool comprising:
a housing defining a head housing portion;
a motor supported within the head housing portion and including an output shaft defining an axis;
a gear case aligned with the motor along the axis and supported within the head housing portion;
a gear assembly engaged with the output shaft and supported within the gear case, the gear assembly including
a pinion gear coupled to the output shaft,
a plurality of planet gears meshed with the pinion gear, and
a ring gear meshed with the planet gears;
a seal positioned axially between the gear case and the ring gear; and
a drive assembly driven by the planet gears and supported within the head housing portion.

11. The power tool of claim 10, wherein the seal interfaces with a flange of the gear case.

12. The power tool of claim 11, wherein the seal is U-shaped in cross section and couples to and receives the flange of the gear case.

13. The power tool of claim 10, wherein the gear case includes a tab extending radially outward in a direction perpendicular to the axis towards the housing, the tab is received within a recess of the housing to inhibit rotation of the gear case relative to the housing.

14. The power tool of claim 10, wherein the ring gear includes a protrusion extending from a rearward face of the ring gear in a direction along the axis, the protrusion is seated within an aperture of the housing.

15. The power tool of claim 14, wherein the aperture extends through a dividing wall in the housing that separates the motor from the ring gear.

16. A power tool comprising:
a housing including
a first housing portion,
a second housing portion coupled to the first housing portion, the first and second housing portions defining a head housing portion, and
a nose cap coupled to the head housing portion;
a motor supported within the head housing portion;
a gear case supported by the head housing portion, the nose cap coupled to the gear case;
a gear assembly engaged with the motor and supported within the gear case; and
a drive assembly driven by the gear assembly and supported within the head housing portion.

17. The power tool of claim 16, wherein the motor defines an axis, and wherein the gear case includes a tab extending radially outward in a direction perpendicular to the axis towards the housing, the tab is received within a recess of the housing to inhibit rotation of the gear case relative to the housing.

18. The power tool of claim 17, wherein
the tab is a first of a plurality of tabs extending radially outward in a direction perpendicular to the axis towards the housing,
the recess in the housing is a first of a plurality of recesses in the housing, and
each tab is received within one of the plurality of recesses in the housing to inhibit rotation of the gear case relative to the housing.

19. The power tool of claim 17, wherein the gear case includes a projection extending radially outward in a direction perpendicular to the axis towards the housing, the projection is received within a recess of the nose cap to inhibit rotation of the gear case relative to the nose cap.

20. The power tool of claim 16, wherein the gear case is completely enclosed by the head housing portion.
